(19) United States
(12) Patent Application Publication
(10) Pub. No.: US 2010/0039236 A1
(43) Pub. Date: Feb. 18, 2010

(54) TIME-BASED OPERATIONAL WINDOW FOR RFID TAGS

(76) Inventors: Kenneth L. Greenlee, Raleigh, NC (US); Christian L. Hunt, Cary, NC (US); Anne I. Ryan, Palo Alto, CA (US)

Correspondence Address: IBM CORPORATION, 3039 CORNWALLIS RD., DEPT. T81 / B503, PO BOX 12195, RESEARCH TRIANGLE PARK, NC, 27709, US

(21) Appl. No.: 12/191,473

(22) Filed: Aug. 14, 2008

(51) Int. Cl. H04Q 5/22

(52) U.S. Cl. 340/10.2

(57) ABSTRACT

The present invention provides a time-based operational window for RFID tags. A method in accordance with an embodiment includes: associating an operational window with the RFID tag; determining if a current time is within the operational window; operating the RFID tag if the current time is within the operational window; and not operating the RFID tag if the current time is outside the operational window.

### FIELD OF THE INVENTION

The present invention relates generally to RFID tags, and more particularly to a time-based operational window for RFID tags.

### BACKGROUND OF THE INVENTION

With the widespread use of radio frequency identification (RFID) tags in many industries, including transportation, retail, and health care, countless RFID tags with enormous amounts of data are used and then forgotten about in homes, warehouses, stores, and hospitals. Although it could be argued that much of the data on the RFID tags is no longer relevant, such as data of expired food or already delivered packages, many consumers would not like the idea that the RFID tags on many items will still be readable after purchase; the RFID tag data on an item could then be read by another party and associated with the purchaser. This information could then be collected and used by marketers, for example, in ways consumers would eschew if they were aware of them.

One way to delete data on an RFID tag is to permanently disable the tag at the point of sale with a “kill” command. This, however, requires a command issued from an RFID reader and would require an extra step for each tagged item in an RFID system. Further, killing the RFID tag on items would also terminate RFID benefits to consumers. For example, smart appliances such as RFID refrigerators or medicine cabinets would be rendered un-useful. Further, if an RFID chip is killed, returning an item to a store would require re-activation of the chip or retagging of the item, which would be a burden to the consumer.

Another way of disabling an RFID tag is to buy a device known as an RFID-zapper, which allows consumers to wipe tag data individually. Further, an RFID tag can be disabled by physically removing and/or destroying the tag. However, removing RFID tags can be quite a difficult task, since some RFID tags are very small (less than a half-millimeter square, and as thin as a sheet of paper), while others may be hidden or embedded inside a product where consumers cannot see them. In addition, new technologies allow RFID tags to be “printed” right on a product and may not be removable at all.

### SUMMARY OF THE INVENTION

The present invention provides a time-based operational window for RFID tags.

An embodiment of the present invention is directed to a method for time-based operation of a radio frequency identification (RFID) tag, comprising: associating an operational window with the RFID tag; determining if a current time is within the operational window; operating the RFID tag if the current time is within the operational window; and not operating the RFID tag if the current time is outside the operational window.

Another embodiment of the present invention is directed to a radio frequency identification (RFID) tag, comprising: an operational window; a system for determining if a current time is within the operational window; and a system for operating the RFID tag if a current time is within the operational window, wherein the RFID tag does not operate if the current time is outside the operational window.

Another embodiment of the present invention is directed to a radio frequency identification (RFID) system, comprising: an RFID reader; an RFID tag comprising an operational window; a system for determining if a current time is within the operational window; and a system for operating the RFID tag if a current time is within the operational window, wherein the RFID tag does not operate if the current time is outside the operational window.

### BRIEF DESCRIPTION OF THE DRAWINGS

These and other features will be more readily understood from the following detailed description of the various aspects of the invention taken in conjunction with the accompanying drawings.

FIGS. 1-2 depict the operation of an RFID tag in accordance with an embodiment of the present invention.

FIG. 3-4 depict the operation of an RFID tag in accordance with another embodiment of the present invention.

FIG. 5 depicts a flow diagram of an illustrative process in accordance with an embodiment of the present invention.

FIG. 6 depicts a flow diagram of an illustrative process in accordance with another embodiment of the present invention.

### DETAILED DESCRIPTION OF THE INVENTION

The present invention provides a time-based operational window for RFID tags.

In the following discussion, it is assumed that the reader has an understanding of the operation of RFID tags/readers commensurate with one skilled in the art. To this extent, a detailed discussion of the operation of RFID tags/readers is not provided herein.

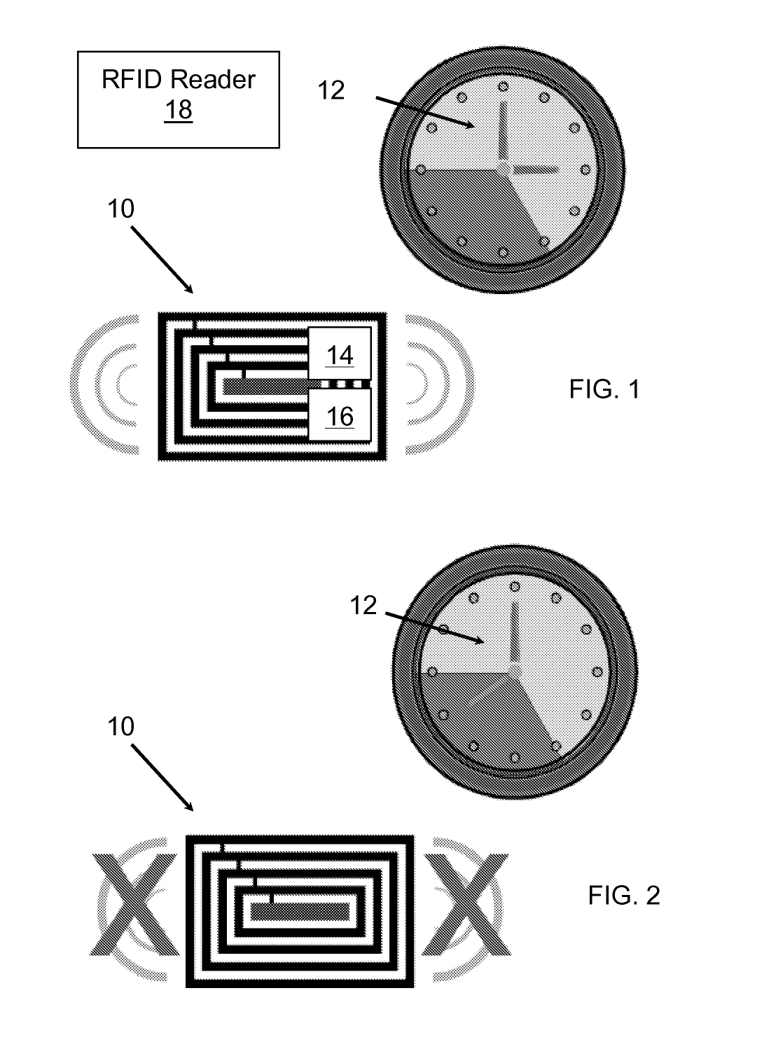

An embodiment of the present invention is depicted in FIGS. 1 and 2. In this embodiment, an RFID tag 10 has a timed operational window 12, which can comprise one or more predetermined periods of time (e.g., hours). For example, as shown in FIG. 1, the operational window 12 is set such that the RFID tag 10 is to be active only between 9:00 AM and 5:00 PM each day. If the current time is 3:00 PM, the RFID tag 10 responds/broadcasts because the current time is within the operational window 12. If, however, as shown in FIG. 2, the current time is 8:00 AM, the RFID tag 10 does not respond/broadcast because the current time is not within the operational window 12. This operational window 12 may be effective for a predetermined number of days (e.g., one day, a week, a month, Mondays, Wednesdays, and Fridays, etc.) or other suitable period of time.

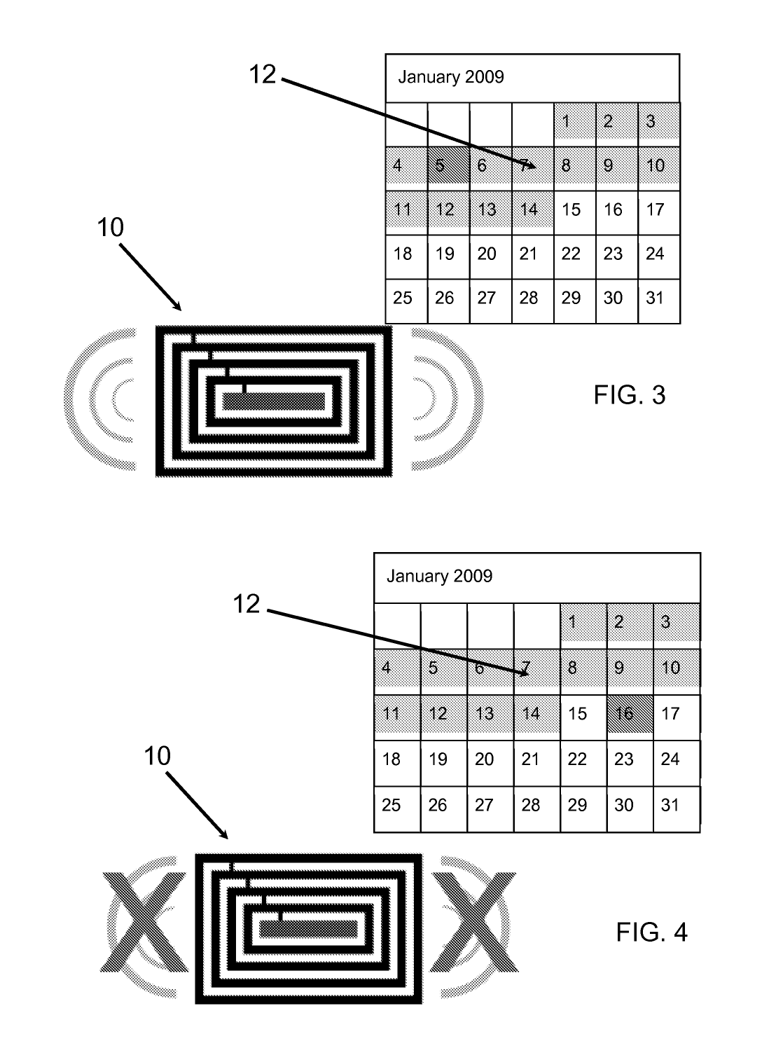

Another embodiment of the present invention is depicted in FIGS. 3 and 4. In this embodiment, an RFID tag 10 has a timed operational window 12 that is set to be active for a predetermined period of time (e.g., days). For example, as shown, the operational window 12 is set such that the RFID tag 10 is to be active from 01/01/09 through 01/14/09. If the current date is, for example, 01/05/09, as shown in FIG. 3, the RFID tag 10 responds/broadcasts because the date is within the operational window 12. If, however, as shown in FIG. 4, the current date is, for example, 01/16/09, the RFID tag 10 does not respond/broadcast because the date is not within the operational window 12.

In general, the operational window 12 is application specific. As such, any suitable operational window 12 can be used in the practice of the present invention.

As depicted in FIG. 1, the RFID tag 10 used in the present invention includes a power supply 14 for powering the logic 16 that provides a clock/calendar and determines whether a response/broadcast is allowed based on the operational window 12 and the current time provided by the clock/calendar. That is, if the current time is within the operational window 12 programmed in the logic, then respond/broadcast; otherwise, do not respond/broadcast. Specifically, for a semi-active RFID tag, the RFID tag 10 only responds to an RFID reader 18 during the operational window 12. For an active RFID tag 10, the RFID tag only broadcasts to the RFID reader 18 during the operational window 12.

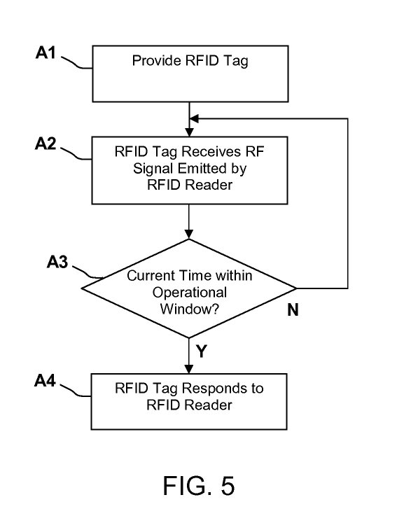

FIG. 5 depicts a flow diagram of an illustrative process in accordance with an embodiment of the present invention. At A1, a semi-active RFID tag, which has been programmed with an operational window, is provided on an item. At A2, the RFID tag receives an RF signal emitted by an RFID reader. At A3, if the current time is within the operational window of the RFID tag, the RFID tag responds to the RFID reader at A4. Otherwise, if the current time is outside the operational window, the RFID tag does not respond to the RFID reader. Flow then returns to A2.

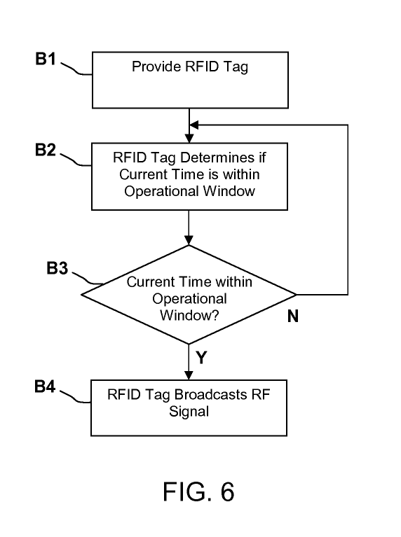

FIG. 6 depicts a flow diagram of an illustrative process in accordance with another embodiment of the present invention. At B1, an active RFID tag, which has been programmed with an operational window, is provided on an item. At B2, the RFID tag determines if the current time is within the operational window. If the current time is within the operational window, the RFID tag broadcasts an RF signal. Otherwise, if the current time is outside the operational window, the RFID tag does not broadcast an RF signal. Flow then returns to B2.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

What is claimed is:

1. A method for time-based operation of a radio frequency identification (RFID) tag, comprising:
associating an operational window with the RFID tag;
determining if a current time is within the operational window;
operating the RFID tag if the current time is within the operational window; and
not operating the RFID tag if the current time is outside the operational window.

2. The method of claim 1, further comprising:
providing the RFID tag with logic programmed with the operational window.

3. The method of claim 2, wherein the RFID tag comprises a power supply for powering the logic.

4. The method of claim 1, wherein the operational window comprises at least one predetermined period of time.

5. The method of claim 1, wherein operating the RFID tag comprises responding to an RF signal emitted by the RFID reader.

6. The method of claim 1, wherein operating the RFID tag comprises broadcasting an RF signal to the RFID reader.

7. A radio frequency identification (RFID) tag, comprising:
an operational window;
a system for determining if a current time is within the operational window; and
a system for operating the RFID tag if a current time is within the operational window, wherein the RFID tag does not operate if the current time is outside the operational window.

8. The RFID tag of claim 7, further comprising:
logic programmed with the operational window.

9. The RFID tag of claim 8, further comprising:
a power supply for powering the logic.

10. The RFID tag of claim 7, wherein the operational window comprises at least one predetermined period of time.

11. The RFID tag of claim 7, wherein operating the RFID tag comprises responding to an RF signal emitted by the RFID reader.

12. The RFID tag of claim 7, wherein operating the RFID tag comprises broadcasting an RF signal to the RFID reader.

13. A radio frequency identification (RFID) system, comprising:
an RFID reader;
an RFID tag comprising an operational window;
a system for determining if a current time is within the operational window; and
a system for operating the RFID tag if a current time is within the operational window, wherein the RFID tag does not operate if the current time is outside the operational window.

14. The RFID system of claim 13, further comprising:
logic on the RFID tag programmed with the operational window.

15. The RFID system of claim 14, further comprising:
a power supply on the RFID tag for powering the logic.

16. The RFID system of claim 13, wherein the operational window comprises at least one predetermined period of time.

17. The RFID system of claim 13, wherein operating the RFID tag comprises responding to an RF signal emitted by the RFID reader.

18. The RFID system of claim 13, wherein operating the RFID tag comprises broadcasting an RF signal to the RFID reader.
